(19) United States
(12) Patent Application Publication
(10) Pub. No.: US 2017/0047567 A1
(43) Pub. Date: Feb. 16, 2017

(54) BIAXIALLY ORIENTED FILM HAVING A PARTICLE-CONTAINING POROUS LAYER

(71) Applicant: Treofan Germany GmbH & Co. KG, Neunkirchen (DE)

(72) Inventors: Bertram SCHMITZ, Saarbrücken (DE); Allan CRIGHTON, Heidelberg (DE); Thilo MOHR, Homburg (DE); Peter SCHLACHTER, Bischmisheim (DE)

(21) Appl. No.: 15/306,615

(22) PCT Filed: Apr. 21, 2015
(86) PCT No.: PCT/EP2015/000829

§ 371 Date: Oct. 25, 2016

(30) Foreign Application Priority Data
Apr. 25, 2014 (DE) 10 2014 005 890.5
Feb. 3, 2015 (DE) 10 2015 001 215.0

(51) Int. Cl. H01M 2/16; B29C 47/00; B29C 47/06; H01M 2/14; B32B 5/18; B32B 27/20; B29C 44/56; B32B 27/32; B29C 44/34; B29C 55/14

(52) U.S. Cl. CPC H01M 2/166; B29C 44/3469; B29C 47/0057; B29C 47/0004; B29C 47/065; B29C 55/143; B32B 5/18; B32B 27/205; B29C 44/5672; B32B 27/32; H01M 2/145; H01M 2/1686; B29K 2023/12

(57) ABSTRACT

The invention relates to a biaxially oriented single-layer or multilayer porous film which comprises at least one porous layer and said layer comprises at least one propylene polymer, at least one β-nucleating agent and particles, said particles having a melting point of over 200° C. and at most an agglomerate or at most a particle having a particle size of >1 μm being detectable on a REM recording of a film sample of 10mm2.

The present invention relates to a biaxially oriented film having at least one particle-containing porous layer and to its use as a separator, as well as to a process for the production of said film.

Modern devices require a source of energy such as batteries or accumulators which enable them to be used independently of location. The disadvantage with batteries is that they have to be disposed of. Thus, more and more accumulators (secondary batteries) are being used which can be recharged again and again from the main power supply with the aid of charging devices. In normal use, conventional nickel-cadmium accumulators (NiCd accumulators) can, for example, have a service life of approximately 1000 charging cycles. In high energy or high performance systems, lithium, lithium ion, lithium-polymer and alkaline-earth batteries are increasingly being used as accumulators.

Batteries and accumulators always consist of two electrodes which are immersed in an electrolyte solution, and a separator which separates the anode and cathode. The various types of accumulator differ in the electrode material used, the electrolytes and the separator employed. A battery separator is designed to spatially separate the cathode and anode in batteries, or negative and positive electrodes in accumulators. The separator has to be a barrier which isolates the two electrodes electrically from each other in order to avoid internal short-circuits. At the same time, however, the separator has to be permeable to ions, so that the electrochemical reactions can take place in the cell.

A battery separator has to be thin so that the internal resistance is as low as possible and a high packing density and thus energy density can be obtained in the battery. Good performance data and high capacities are only possible in this manner.

In addition, the separators have to absorb the electrolyte and guarantee gas exchange when the cells are filled. While woven materials inter alia were used in the past, nowadays fine-pored materials such as nonwovens and membranes are overwhelmingly employed.

In lithium batteries, the occurrence of short-circuits is a problem. Under thermal loads, the battery separator can melt in lithium ion batteries, resulting in a short-circuit with devastating consequences. Similar dangers occur if lithium batteries are mechanically damaged or are overloaded because of defective electronics in the charging equipment.

In order to increase the safety of lithium ion batteries, in the past, shut-down membranes were developed. The pores of these special separators close in a very short time at a specific temperature which is significantly below the melting point or the ignition point of lithium. In this manner, the catastrophic consequences of a short-circuit in lithium batteries is substantially avoided.

However, at the same time, separators also need high mechanical strength, which is ensured by using materials with high melting temperatures. Thus, for example, polypropylene membranes are advantageous because of their good resistance to perforation, but the melting point of polypropylene, at about 164° C., is very close to the ignition point of lithium (170° C.).

High energy batteries based on lithium technology are employed in applications which require the greatest amount of electrical energy to be available in the least amount of space. This is the case, for example, with traction batteries for use in electric vehicles, but also in other mobile applications in which a maximum energy density is required for a low weight such as, for example, in air and space travel. At the moment, in high energy batteries, energy densities of 350 to 400 Wh/L or 150 to 200 Wh/kg can be obtained. These high energy densities are obtained by using special electrode materials (for example Li—CoO₂) and the minimal use of housing materials. Thus, in pouch cell type Li batteries, the individual battery units are separated simply by a film. Because of this, the demands placed on separators for these cells are high, since if an internal short-circuit and overheating occur, the explosive combustion reactions spread to the adjacent cells.

Separators for these applications must be as thin as possible in order to guarantee a small footprint; furthermore, to keep the internal resistance low, they must also have a high porosity. In the case of overheating or mechanical damage, positive and negative electrodes have to remain separated at all costs in order to prevent further chemical reactions which could result in fire or explosion of the batteries.

In the prior art, it is known to combine polypropylene membranes with other layers which are constructed from materials with lower melting points, for example from polyethylene. In the case of overheating by a short-circuit or other external influences, the polyethylene layer melts and close the pores of the porous polypropylene layer, whereupon the flow of ions, and thus the flow of current, in the battery is interrupted.

However, the polypropylene layer also melts if the temperature rises further (>160° C.), and an internal short-circuit due to contact of the anode and cathode and the resulting problems such as spontaneous combustion and explosion can no longer be avoided. In addition, adhesion of the polyethylene layers to polypropylene layers is problematic, so that these layers can only be combined by means of lamination, or only selected polymers from these two classes can be co-extruded. These separators are not safe enough in high energy applications. A film of this type is described in WO 2010048395.

US 2011171523 describes a heat-resistant separator which is obtained by a solvent process. In this regard, in a first step, inorganic particles (chalk, silicates or aluminium oxide) are compounded into the raw material (UHMW-PE) together with an oil. This mixture is then extruded through a nozzle to form a pre-film. Next, the oil is dissolved out of the pre-film by means of a solvent in order to create pores. Next, this film is stretched to form the separator. Thus, in this separator, even with severe overheating, the inorganic particles ensure that the anode and cathode are separated in the battery.

This process suffers from the disadvantage that the particles contribute to weakening of the mechanical properties of the separator and defects and a non-uniform pore structure may arise because of agglomerates.

US 2007020525 describes a ceramic separator which is obtained by processing inorganic particles with a polymer-based binder. This separator also ensures that the anode and cathode in the battery remain separated under severe overheating. However, the production process is complicated and the mechanical properties of the separator are insufficient.

WO 2013 083280 describes a biaxially oriented, single- or multi-layered porous film which comprises an inorganic, preferably ceramic, coating. The original porosity of the film is reduced by the ceramic coating to only a small extent. The porous film has a Gurley value of <1500 s. According to that disclosure, polypropylene separators with a specific surface structure, even without using primers, as opposed to water-based inorganic, preferably ceramic coatings, exhibit sufficient adhesion.

Other membranes are known in the art which are combined with temperature-stable layers which also ensure isolation of the electrodes from each other after melting of the separator. Frequently in this case, adhesion of these layers to the substrate is a problem, so that these layers can only be combined with the actual membrane by lamination or coating. In the context of the present invention, it has been discovered that the effectiveness of ceramic coatings is also dependent on the quality of the coating. For efficient isolation of the electrodes, after the membrane melts, a continuous isolation layer of the temperature-resistant material must remain which itself must be free of any defects, holes or variations in thickness. This is a particular challenge as regards producing the membrane to be coated as regards the uniformity of thickness and the surface quality.

Furthermore, the separator materials with the temperature-stable protective layer have to be as thin as possible in order to take up a small amount of space, to keep the internal resistance low and to have a high porosity. The coating has a negative effect on these properties, since the coating results in increasing the thickness of the membrane and reducing the porosity, and the surface structure of the film is compromised.

In principle, there is also a drive for higher run speeds when producing the separator films. Because of the fragile network structure, higher speeds during the production of porous films is particularly critical, as this is often associated with tearing and quality defects so that the process as a whole does not become more economical.

Polyolefin separators can now be produced using various processes: filler processes; cold stretching, extraction processes and β-crystallite processes. These processes are primarily distinguished by the various mechanisms by means of which the pores are produced.

As an example, adding very large quantities of fillers can produce porous films. The pores occur through stretching due to the incompatibility of the fillers with the polymer matrix. The large quantities of filler of up to 40% by weight which are necessary to obtain high porosities, however, substantially compromise the mechanical strength despite large amounts of stretching, so that these products cannot be used as separators in a high energy cell.

In so-called extraction processes, in principle, the pores are produced by dissolving a component out of the polymer matrix using suitable solvents. Many variations have been developed in this regard, which differ in the type of additive and the appropriate solvents. Both organic and inorganic additives may be used for extraction. This extraction may be carried out as the final step in the process for the production of the film, or be combined with subsequent stretching. The disadvantage in this case is the ecologically and economically questionable extraction step.

An older but successful process is based on stretching the polymer matrix at very low temperatures (cold stretching). To this end, the film is initially extruded and then, in order to increase the crystalline fraction, it is tempered for a few hours. In the next step of the process, cold stretching is carried out in the longitudinal direction at very low temperatures in order to produce a large quantity of defects in the form of very small microcracks. This pre-stretched film with the defects is then stretched once again at high temperatures with higher factors, again in the same direction, whereupon the defects are enlarged into pores which form a network-like structure. These films combine high porosities and good mechanical strength in the direction in which they have been stretched, generally the longitudinal direction. The mechanical strength in the transverse direction, however, remains insufficient, whereupon the resistance to perforation is poor and a high tendency to split occurs in the longitudinal direction. Overall, the process is cost-intensive.

A further known process for the production of porous films is based on mixing β-nucleation agents with polypropylene. Because of the β-nucleation agent, the polypropylene forms what are known as β-crystallites in large concentrations when the melt cools. During the subsequent longitudinal stretching, the β-phase is transformed into the alpha modification of the polypropylene. Because these various crystalline forms differ in density, here again, many microscopic defects are initially formed which are torn into pores by the stretching. The films produced using this process have good porosities and good mechanical strengths in the longitudinal and transverse directions and also are very economical. These films will hereinafter also be termed “β-porous films”. In order to improve the porosity, a greater orientation in the longitudinal direction can be introduced prior to transverse stretching.

The aim of the present invention is thus to provide a film which, as a separator, ensures isolation of the electrodes even at very high temperatures or mechanical damage to the batteries. This isolating function must also be retained when the temperatures inside the battery are over the melting point of the polymers of the separators. Moreover, this film should be capable of being produced efficiently and cost-effectively.

These β-porous films are fundamentally in need of improvement. It would be desirable to provide a process for the production of porous films which could be operated with a faster process speed. In this regard, it should have good run stability. This means that when producing the film, few or even no tearing should occur, even at high process speeds. The ongoing concern is to improve the porosity, but to obtain low Gurley values, in particular via few cloased zones on the film surface. A further object is the provision of a porous film with a low thickness, wherein even with a low thickness for the film, high process speed production should still be possible and low Gurley values should be obtained by the film.

Thus, in a further aspect, the present invention provides a porous film with an improved Gurley value, i.e. a good permeability.

In a further aspect, the present invention provides for a high process speed in the production of porous films with a low Gurley value.

These and further aims are accomplished by means of a biaxially oriented, single- or multi-layered porous film which comprises at least one porous layer, wherein this layer contains at least one propylene polymer, a β-nucleation agent and particles, wherein the particles have a melting point of more than 200° C. and at most 1 agglomerate or particle with a particle size of >1 μm is detectable on a SEM image of a 10 mm² film sample.

Surprisingly, membranes which are based on the film in accordance with the invention exhibit a sufficient protection against internal short-circuits when used as separators in highly reactive batteries and accumulators by adding high melting point particles. The particles in the film form an effective isolation, even at very high temperatures of more than 160° C. (melting point of propylene polymers), which isolation separates the electrodes from each other.

Furthermore, it has surprisingly been discovered that the addition of high melting point particles in the porous layer reduces the Gurley value of porous films. More surprisingly, it is possible to increase the process speed by adding the particles. Furthermore, it has surprisingly been discovered that the addition of said particles effectively reduces the number of tearing, even at increased process speeds.

Furthermore, it has also surprisingly been found that lower quantities of β-crystalline polypropylene in the pre-film are nevertheless sufficient to obtain films with very low Gurley values. Thus, the invention allows the quantity of β-nucleation agents in the porous film to be reduced, or even to completely dispense with the β-nucleation agent.

In the context of the present invention, “particles” are small parts which have a melting point of more than 200° C.

The β-porous films in accordance with the invention may be constructed as single- or multi-layers and comprise at least one porous layer which is constructed from propylene polymers, preferably propylene homopolymers and/or propylene block copolymers, and in general contains at least one β-nucleation agent, as well as high melting point particles in accordance with the invention. Optionally, other additional polyolefins may be added in small quantities, with the proviso that they do not have a negative influence on the porosity and other essential properties. Furthermore, the porous layer optionally additionally contains the usual additives, for example stabilizers and/or neutralization agents, respectively in effective quantities.

Suitable propylene homopolymers for the porous layer contain 98% to 100% by weight, preferably 99% to 100% by weight of propylene units and have a melting point (DSC) of 150° C. or more, preferably 155° C. to 170° C., and in general a melt flow index of 0.5 to 10 g/10 min, preferably 2 to 8 g/10 min, at 230° C. and under a load of 2.16 kg (DIN 53735). Isotactic propylene homopolymers with a n-heptane soluble proportion of less than 15% by weight, preferably 1% to 10% by weight, constitute preferred propylene homopolymers for the layer. Advantageously, isotactic propylene homopolymers with a high chain isotacticity of at least 96%, advantageously 97-99% (¹³C NMR; triad method) are used. These raw materials are known in the prior art as HIPP polymers (Highly Isotactive PolyPropylene) or HCPP (Highly Crystalline PolyPropylene) and are characterized by high stereoregularity of the polymer chains, higher crystallinity and a higher melting point (compared with propylene polymers with a ¹³C NMR isotacticity of 90% to <96%, which may also be used).

Propylene block copolymers have a melting point of more than 140° C. to 170° C., preferably 145° C. to 165° C., in particular 150° C. to 160° C., and a melting range which begins at over 120° C., preferably in the range 125-160° C. The co-monomer content, preferably that of ethylene, is between 1% and 20% by weight, preferably between 1% and 10% by weight, for example. The melt flow index of the propylene block copolymers is generally in the range 1 to 20 g/min, preferably 1 to 10 g/min.

If appropriate, the porous layer may additionally contain other polyolefins, with the proviso that they do not have a negative influence on the properties, in particular the porosity and the mechanical strength. Examples of other polyolefins are random copolymers of ethylene and propylene with an ethylene content of 20% by weight or less, random copolymers of propylene with C₄-C₈ olefins with an olefin content of 20% by weight or less, terpolymers of propylene, ethylene and butylene with an ethylene content of 10% by weight or less and with a butylene content of 15% by weight or less.

In a preferred embodiment, the porous layer is formed from propylene homopolymers and/or propylene block copolymers and β-nucleation agents and particles alone, as well as optional stabilizers and neutralization agents.

In a further embodiment, the porous layer is formed from propylene homopolymers and/or propylene block copolymers and particles alone, as well as optional stabilizers and neutralization agents. These embodiments do not contain any β-nucleation agents.

Any known additives which promote the formation of β-crystals of the polypropylene upon cooling of a polypropylene melt are suitable as the β-nucleation agent for the porous layer. β-nucleation agents of this type, and also their action in a polypropylene matrix, are generally known in the art and will be described below in detail.

Various crystalline phases are known for polypropylene. As a melt cools, primarily α-crystalline polypropylene usually primarily forms, which has a melting point in the range 155-170° C., preferably 158-162° C. By using a specific temperature profile, upon cooling the melt, a small proportion of β-crystalline phase may be produced which, in contrast to the monoclinic α-modification, has a substantially lower melting point of 145-152° C., preferably 148-150° C. In the prior art, additives are known which result in a raised proportion of the β-modification upon cooling of the polypropylene examples are γ-quinacridone, dihydroquinacridine or calcium salts of phthalic acid.

For the purposes of the present invention, preferably, highly active β-nucleation agents are used which, upon cooling of a propylene homopolymer melt, produce a β proportion of 40-95%, preferably 50-85% (DSC). The β proportion is determined from a DSC of the cooled propylene homopolymer melt. As an example, a two-component β-nucleation agent of calcium carbonate and organic dicarboxylic acids as described in DE 3 610 644, to which reference is specifically made hereby, is preferably used. Particularly preferably, calcium salts of the dicarboxylic acids, such as calcium pimelate or calcium suberate as described in DE 4 420 989, to which reference is also specifically made hereby, is used. Furthermore, the dicarboxamides, in particular N,N-dicyclohexyl-2,6-naphthalene-dicarboxamide, described in EP 0 557 721 are suitable β-nucleation agents.

In addition to the β-nucleation agents, it is important to maintain a specific temperature range and dwell time at these temperatures when cooling the unstretched molten film it order to obtain a high proportion of β-crystalline polypropylene. Cooling the molten film is preferably carried out at a temperature of 60° C. to 140° C., in particular 80° C. to 130° C., for example 85° C. to 128° C. Slow cooling does promote the growth of β-crystallites, and so the take-off speed, i.e. the speed at which the molten film runs over the first cooling roller, should be slow so that the required dwell times are sufficiently long at the selected temperatures. Since the present invention allows for high process speeds, in the process in accordance with the invention, the take-off speeds can also be varied in principle within a relatively wide range for porous films. The take-off speed is generally 1 to 100 m/min, preferably 1.2 to 60 m/min, in particular 1.3 to 40 m/min and particularly preferably 1.5 to 25 m/min or 1 to 20 m/min. The dwell time can be lengthened or shortened appropriately and amounts, for example, to 10 to 300 s; preferably 20 to 200 s.

The porous layer generally contains 40% to <98% by weight, preferably 40% to 90% by weight of propylene homopolymers and/or propylene block copolymers and in general 0.001% to 5% by weight, preferably 50 to 1000 ppm of at least one β-nucleation agent and 2% to <70% by weight of particles, with respect to the weight of the porous layer. For embodiments without β-nucleation agents in the porous layer, the proportion of propylene homopolymers and/or propylene block copolymers are raised accordingly. In the case in which further polyolefins are contained in the layer, the proportion of propylene homopolymers or block components are reduced accordingly. In general, the quantity of additional polymers in the porous layer is 0 to <10% by weight, preferably 0 to 5% by weight, in particular 0.5% to 2% by weight, if they are added. In similar manner, the proportion of said propylene homopolymer or propylene block copolymer proportion will be reduced when larger quantities of up to 5% by weight of nucleation agents are used. In addition, the layer may contain the usual stabilizers and neutralization agents as well as further additives if appropriate, in the usual small quantities of less than 2% by weight.

In a preferred embodiment, the porous layer contains a blend of propylene homopolymer and propylene block copolymer as the polymers. The porous layer in these embodiments generally contains 10% to 93% by weight, preferably 20% to 90% by weight of propylene homopolymers and 5% to 88% by weight, preferably 10% to 60% by weight of propylene block copolymer, and 0.001% to 5% by weight, preferably 50 to 10000 ppm of at least one β-nucleation agent, and 2% to 60% by weight of particles, with respect to the weight of the porous layer, as well as the optional additives already mentioned, such as stabilizers and neutralization agents. Here again, it may contain further polyolefins in a quantity of 0 to <10% by weight, preferably 0 to 5% by weight, in particular 0.5% to 2% by weight, and the proportion of propylene homopolymers or block copolymers will then be reduced accordingly.

Particularly preferred embodiments of the porous film in accordance with the invention contain 50 to 10000 ppm, preferably 50 to 5000 ppm, in particular 50 to 2000 ppm of calcium pimelate or calcium suberate as the β-nucleation agent in the porous layer.

The porous film may be single- or multi-layered. The thickness of the film is generally in the range 10 to 100 μm, preferably 15 to 60 μm, for example 15 to 40 μm.

The surface of the film may be provided with a corona, flame or plasma treatment, for example in order to improve filling with electrolytes and/or to improve the adhesive properties. The addition of particles in accordance with the invention also means that porous films with a thickness of less than 25 μm can be produced at a higher process speed and/or with fewer tearing.

In a simple embodiment, the film is single-layered and thus consists only of the particle-containing porous layer described above. In this case, the proportion of particles is preferably 5% to 50% by weight, in particular 10-40% by weight with respect to the weight of the film.

In a further embodiment, the film is multi-layered and comprises at least two of the particle-containing porous layers described above, differing in the particle content and/or the polymers.

In a further embodiment, the particle-containing porous layer is a single sided outer cover layer I on a further porous layer II. In this case, the proportion of particles in the cover layer I is preferably 10% to 70% by weight, in particular 15% to 60% by weight with respect to the weight of the cover layer I. These films thus comprise at least the particle-containing porous cover layer I and a further porous layer II.

In a further embodiment, particle-containing porous layers are applied as outer cover layers to a porous layer II on both sides. In this case, the proportion of particles in the two cover layers, respectively independently of each other, is preferably 10% to 70% by weight, in particular 15% to 60% by weight with respect to the weight of the respective cover layer.

Common to these embodiments is the fact that all of the layers of the film are porous and thus also the films themselves which result from this configuration of layers are porous films. In the multi-layered embodiment, the respective composition of the particle-containing layer/s I and/or layer/s II may be the same or different.

In principle, the further porous layer/s II are constructed in the same manner as the particle-containing porous layer described above, however without any particles. The proportion of propylene polymers in these porous layers II is correspondingly increased. The further porous layer/s is/are thus composed as follows.

The further porous layer II in general contains 45% to <100% by weight, preferably 50% to 95% by weight, of propylene homopolymers and/or propylene block copolymers and 0.001% to 5% by weight, preferably 50-10000 ppm of at least one s-nucleation agent, with respect to the weight of the porous layer. In the event that further polyolefins are contained in the layer II, the proportion of propylene homopolymers or of block copolymers is correspondingly reduced. In general, the quantity of the additional polymers in the layer II is from 0 to <10% by weight, preferably 0 to 5% by weight, in particular 0.5% to 2% by weight, when they are added. In similar manner, said proportion of propylene homopolymer or propylene block copolymer is reduced when larger quantities of up to 5% by weight of nucleation agents are used. In addition, the layer II may also contain the usual stabilizers and neutralization agents, as well as optional further additives in the usual small quantities of less than 2% by weight.

In further embodiments of the invention, the porous layer may also be combined with additional non-porous layers if, for example the special pore structure is to be used for other purposes. These films then have no gas permeability and comprise at least one porous particle-containing layer I as the cover layer/s, inner intermediate layer/s or as the base layer of a multi-layered embodiment of the film.

The density of the porous film or the porous layer is generally in the range 0.1 to 0.6 g/cm³, preferably 0.2 to 0.5 g/cm³. The density of the film for embodiments with further non-porous layers may vary within a wide range.

The porous films in accordance with the invention are characterized by the following further properties:

The maximum pore size measured (using bubble point) of the porous film in accordance with the invention is generally <350 nm, and is preferably in the range 20 to 350 nm, in particular 40 to 300 nm, particularly preferably 40 to 200 nm. The mean pore diameter should generally be in the range 20 to 150 nm, preferably in the range 30 to 100 nm, in particular in the range 30 to 80 nm. The porosity of the porous film is generally in the range 30% to 80%, preferably 50% to 70%. The film in accordance with the invention is preferably distinguished by a Gurley value of less than 500 s/100 cm³, in particular less than 200 s/00 cm³, in particular 10 to 150 s/100 cm³.

Adding the particles to the porous layer results in surprising effects which can be advantageously exploited in different ways. It has been discovered that the particles ensure separation of the electrodes even when the temperature inside the battery exceeds the melting temperature of the polymers. This protective action functions both with separators with pores which close when the temperature rises, and also with separators without this shut-down function (increase of the Gurley value of porous film at high temperatures). In this manner, separators formed from the porous film in accordance with the invention offer improved protection against battery fires or even explosions as a consequence of short-circuits, mechanical damage or overheating.

Surprisingly, the added particles have an advantageous effect on the gas permeability of the films. By adding the particles, the Gurley value is reduced compared with a film with an analogous composition without particles. This is surprising given the background that the particles alone as a rule do not trigger any β-nucleation action. Furthermore, in the prior art it is known that particles with a particle size of less than 1 μm in a polypropylene matrix also do not have any vacuole-forming or pore-forming action. Thus, it is not understood how or why these particles contribute to a lower Gurley value.

In this regard, it was also completely unexpected that adding particles, in contrast to what was originally expected, does not cause more frequent tearing in the production of the film. This was surprising, as in the prior art it is known that, for example, agglomerates of nucleation agents result in significantly increasing the frequency of tearing. More recent patent applications describe how a uniform distribution of nucleation agents with a particle size of 5 to 50 nm can be obtained in polypropylene without agglomeration in order to increase the process safety during the production of β-porous films (WO 2011047797 A1).

The particles added in accordance with the invention with a melting point of more than 200° C. comprise inorganic and organic particles. In the context of the present invention, the particles are not substrates which result in a higher proportion of β-crystalline polypropylene. Thus, they are not β-nucleation agents. In the context of the present invention, “particles” are non-vacuole-initiating particles. Preferably, the particles used in accordance with the invention are approximately spherical particles or spherical particles.

Vacuole-initiating particles are known in the art and produce vacuoles when a polypropylene film is stretched. Vacuoles are closed voids, and thus reduce the density of the film compared with the mathematical density of the starting material. In this regard, porous films or layers have a network of interconnected pores. Thus, “pores” are not closed voids. Both porous films and also vacuole-containing films have a density of less than 0.9 g/cm³. The density of vacuole-containing biaxially stretched polypropylene films is generally 0.5 to <0.85 g/cm³. In general, a particle size or more than 1 μm is required for the particles in order to act as vacuole-initiating particles in a polypropylene matrix. Particles can be tested as to whether they are vacuole-initiating particles or non-vacuole-initiating particles using a reference film of propylene homopolymer.

To this end, a biaxially stretched film formed from propylene homopolymer and 8% by weight of the particle to be tested is produced using the conventional. BOPP process. In this regard, the usual stretching conditions were used (longitudinal stretching factor 5 with a stretching temperature of 110° C. and a transverse stretching factor of 9 with a transverse stretching temperature of 140° C.). Subsequently, the density of the film is determined. If the density of the film is ≦0.85 g/cm³, the particles are vacuole-initiating particles. If the density of the film is more than 0.85 g/cm³, preferably more than 0.88 g/cm3, in particular more than ≧0.9 g/cm³, they are non-vacuole-initiating particles within the context of the present invention.

In the context of the present invention, “inorganic particle” means any natural or synthetic minerals, providing that they have the melting point of over 200° C. mentioned above. In the context of the present invention, “inorganic particles” encompasses materials based on silicate compounds, oxidic raw materials, for example metallic oxides, and non-oxidic and non-metallic raw materials.

Examples of inorganic particles are aluminium oxide, aluminium sulphate, barium sulphate, calcium carbonate, magnesium carbonate, silicates such as aluminium silicate (kaolin clay) and magnesium silicate (talc) and silicon dioxide; of these, titanium dioxide, calcium carbonate and silicon dioxide are preferably used.

Suitable silicates include materials which comprise a SiO₄ tetrahedron, for example phyllosilicates or tectosilicates. Examples of suitable oxide raw materials, in particular metallic oxides, are aluminium oxides, zirconium oxides, barium titanate, lead zirconium titanates, ferrites and zinc oxide. Examples of suitable non-oxidic and non-metallic raw materials are silicon carbide, silicon nitride, aluminium nitride, boron nitride, titanium boride and molybdenum silicide.

Oxides of the metals Al, Zr, Si, Sn, Ti and/or Y are preferred. As an example, the manufacture of particles of this type is described in detail in DE-A-10208277.

Particles based on oxides of silicon with the molecular formula SiO₂ as well as mixed oxides with the molecular formula AlNaSiO₂ and oxides of titanium with the molecular formula TiO₂ are particularly preferred, wherein these may be in the crystalline, amorphous or mixed form.

In general, the preferred titanium dioxide particles are used in a proportion of at least 95% by weight of rutile and preferably have a coating of inorganic oxides, as is generally the case with a coating for TiO₂ white pigments in papers or as coatings to improve light fastness. TiO₂ particles with a coating have been described, for example, in EP-A-0 078 633 and EP-A-0 044 515.

The coating optionally also contains organic compounds with polar and non-polar groups. Preferred organic compounds are alkanols and anionic and cationic surfactants containing 8 to 30 C atoms in the alkyl group, in particular fatty acids and primary n-alkanols containing 12 to 24 C atoms, as well as polydiorganosiloxanes and/or polyorganohydrogensiloxanes such as polydimethylsiloxane and polymethylhydrogenosiloxane.

The coating on the TiO₂ particles usually consists of 1 to 12 g, in particular 2 to 6 g, of inorganic oxides, optionally additionally 0.5 to 3 g, in particular 0.7 to 1.5 g, of organic compounds, respectively with respect to 100 g of TiO₂ particles. Particularly advantageously, the TiO₂ particles are coated with Al₂O₃ or with Al₂O₃ and polydimethylsiloxane.

Further suitable inorganic oxides are oxides of aluminium, silicon, zinc or magnesium or mixtures of two or more of these compounds. They are precipitated from aqueous compounds, for example alkalis, in particular sodium aluminate, aluminium hydroxide, aluminium sulphate, aluminium nitrate, sodium silicate or silicic acid in the aqueous suspension.

Organic particles are based on polymers which are incompatible with the propylene polymers of the porous particle-containing layer. Organic particles are preferably based on copolymers of cyclic olefins (COC) as described in EP-A-0 623 463, polyesters, polystyrenes, polyamides, halogenated organic polymers, wherein polyesters such as polybutyleneterephthalates and cycloolefin copolymers are preferred. The organic particles should be incompatible with the polypropylene. In the context of the present invention, “incompatible” means that the material or the polymers are present in the film as separate particles.

The particles have a melting temperature of at least 200° C., in particular at least 250° C., more particularly preferably at least 300° C. Furthermore, the said particles should also not in general undergo any decomposition at the temperatures mentioned. The information cited above may be determined using known methods, for example DSC (differential scanning calorimetry) or TG (thermogravimetry).

The preferred inorganic particles generally have melting points in the range 500° C. to 4000° C., preferably 700° C. to 3000° C., in particular 800° C. to 2500° C. The melting point of TiO₂ is approximately 1850° C., for example.

Organic particles which are used also have a melting point of more than 200° C. and in particular should not undergo any decomposition at the cited temperatures.

Advantageously, the particles have a mean particle size of at most 1 μm, because large particles result in more tearing during production of the film. Mean particle sizes of 10 to 800 nm, in particular 50 to 500 nm, are preferred. The particles should be present in the porous layer in a distribution which is as free of agglomerates as possible, because otherwise, even a few agglomerates beyond a certain critical size of >1 μm, for example, in particular 1 to 3 μm, can increase the frequency of tearing even in small numbers. Thus, the mean particle size contributes to the fact that the film contains no or fewer than 1 agglomerate with a particle size of >1 μm, wherein this is determined on a 10 mm² film sample using SEM imaging. In similar manner, for individual non-agglomerated particles, these have an (absolute) size of less than 1 μm. Correspondingly, said 10 mm² film sample should also have fewer than one or indeed no non-agglomerated particles with a particle size of more than 1 μm. By selecting particles which have little or even no tendency to agglomerate and also a low mean particle size and which have a particle size distribution which means that no or only very few particles have a particle size of >1 μm, porous films can be produced and the very different advantages of the invention can be obtained.

To ensure few agglomerates, it is fundamentally preferred to work the particles in via a batch or by premixing when producing the film. The batches or premixes contain propylene polymers and particles as well as any additional usual additives. When producing the batches, to disperse the particles in the polymer better, a twin-screw extruder is preferably used and/or mixing is carried out at a high shear rate. Adding surface-active substances also contributes to uniform distribution of the particles in the polymers. It is also advantageous to provide the particles with a coating in an earlier step. These measures are recommended, in particular when using inorganic particles. Using these and other measures which are known in the art ensures that agglomerate-free batches or premixes are obtained.

The present invention further concerns a process for the production of the particle-containing porous film in accordance with the invention. In accordance with the invention, the process speed can vary within a wide range. The invention enables higher process speeds to be used; they are no longer associated with a poorer gas permeability or a greater amount of tearing. The speed of the process in accordance with the invention is generally between 3 and 400 m/min, preferably between 5 and 250 m/min, in particular between 6 and 150 m/min or between 6.5 and 100 m/min.

Using this process, the porous film is produced using the flat film extrusion or co-extrusion process, which is known. In the context of this process, mixing of polymers (propylene homopolymer and/or propylene block copolymer) and generally β-nucleation agents and particles and optional further polymers of the respective layer are mixed, melted in an extruder and together and simultaneously extruded or co-extruded through a flat nozzle onto a take-off roller on which the single- or multi-layered molten film solidifies and cools, with the formation of the β-crystallites. The cooling temperatures and cooling times are selected such that as high a proportion of β-crystalline polypropylene occurs in the porous layer of the pre-film as possible. In general, this temperature of the take-off roller or the take-off rollers is 60° C. to 140° C., preferably 80° C. to 130° C. The dwell time at this temperature may vary and should be at least 20 to 300 s, preferably 30 to 100 s. The pre-film obtained in this manner in general contains a proportion of β-crystallites (1^{st} heating) of 40-70%, preferably 50-90% in the porous layer.

This pre-film with the high proportion of β-crystalline polypropylene in the porous layer is then stretched biaxially in a manner such that stretching brings about a transformation of the β-crystallites into α-crystalline polypropylene and the formation of a network-like porous structure. The biaxial stretching (orientation) is generally carried out consecutively, wherein preferably, it is firstly stretched in the longitudinal direction (in the machine direction) and then in the transverse direction (perpendicular to the machine direction).

When stretching in the longitudinal direction, the pre-film is initially guided over one or more heating rollers which heat the film to the suitable temperature. In general, this temperature is below 140° C., preferably 70° C. to 120° C. The longitudinal stretching is then in general carried out with the aid of two rollers which run at different speeds depending on the desired stretching ratio. The longitudinal stretching ratio in this regard is in the range 2:1 to 6:1, preferably 3:1 to 5:1.

After this longitudinal stretching, the film is initially cooled down again over appropriately temperature-controlled rollers. Next, in what is known as the heating zones, it is reheated to the transverse stretching temperature which is generally at a temperature of 120-145° C. Next, transverse stretching is carried out with the aid of an appropriate tenter frame, wherein the transverse stretching ratio is in the range 2:1 to 9:1, preferably 3:1 to 8:1. In order to obtain the high porosity in accordance with the invention, transverse stretching is preferably carried out with a moderate to slow transverse stretching speed of >0 to 40%/s, preferably in the range 0.5% to 30%/s, in particular 1% to 15%/s.

Optionally, after the final stretch, in general the transverse stretch, a surface of the film is treated in a known manner by corona, plasma or flame treatment, so that filling with electrolyte is facilitated.

Finally, thermofixing (heat treatment) is optionally carried out, in which the film is held for about 5 to 500 s, preferably 10 to 300 s at a temperature of 110° C. to 150° C., preferably 125° C. to 145° C., for example over rollers or a hot box. Optionally, the film is run convergently immediately prior to or during thermofixing, wherein the convergence is preferably 5-25%, in particular 8% to 20%. The term “convergence” should be understood to mean a slight running together of the transverse stretching frame, so that the maximum width of the frame at the end of the transverse stretching process is larger than the width at the end of thermofixing. The same is clearly the case for the width of the film web. The degree of convergence of the transverse stretching frame is given as the convergence, which is calculated from the maximum width of the transverse stretching frame Bₘₐₓ and the final film width B_{film} in accordance with the following formula:

Convergence[%]=100×(Bₘₐₓ−B_{film})/Bₘₐₓ

Finally, the film is wound onto a winding device in the usual manner.

In the known sequential process in which longitudinal and transverse stretching are carried out one after the other in one process, it is not only the transverse stretching speed that depends on the process speed. In addition, the take-off speed and the cooling speed vary with the process speed. Thus, these parameters cannot be selected in isolation from each other. This means that under otherwise identical conditions, for a faster process speed, both the transverse stretching speed and also the take-off speed increase, but at the same time the cooling time for the pre-film drops. This can but does not have to constitute an additional problem.

The process speeds mentioned above mean the respective speed, for example in m/min, at which the film runs/is wound onto the final roller.

The process conditions in the process in accordance with the invention for the production of the porous films differ from process conditions which are usually employed when producing a biaxially oriented film. To obtain a high porosity and permeability, both the cooling conditions during solidification to form a pre-film and also the temperatures and factors during stretching are critical. Firstly, by appropriately slow and moderate cooling, i.e. comparatively high temperatures, a high proportion of β-crystallites in the pre-film is aimed for. During the subsequent longitudinal stretching, the β-crystals are transformed into the alpha modification, whereupon defects in the form of microcracks are formed. So that these defects occur in sufficient numbers and in the correct form, the longitudinal stretching must be carried out at comparatively low temperatures. During the transverse stretching, these defects are torn into pores so that the characteristic network structure of these porous films is produced.

These temperatures, which are low compared with conventional BOPP processes, in particular during longitudinal stretching, require higher stretching forces which on the one hand introduce a high orientation into the polymer matrix and on the other hand increase the risk of tearing. The higher the desired porosity, the lower must be the temperatures selected for stretching and the higher must be the stretching factors. The process is thus in principle even more critical the higher the porosity and permeability of the film is to be. The porosity can thus not be increased by any factor using higher stretching factors or lower stretching temperatures. In particular, the reduced longitudinal stretching temperature results in a severely deteriorated run stability of the foil as well as an unwanted increase in the tendency to split. The porosity can thus not be further improved by lower longitudinal stretching temperatures of less than 70° C., for example.

Furthermore, it is possible to influence the porosity and permeability of the film additionally by means of the stretching speed during transverse stretching. A slow transverse stretching speed increases the porosity and permeability further without resulting in more tearing or other perturbances during the production process. The slow process speed however, increases the production costs considerably.

The addition of particles in accordance with the invention supports the formation of the porous structure extremely advantageously, although the particles alone do not act to form any pores. It appears that the particles, in combination with a certain quantity of β-crystalline polypropylene, support the formation of the pore structure in a surprising manner, so that for a given proportion of β-crystallites in the pre-film, adding particles produces a substantially higher porosity which cannot be replicated for a given β-fraction without that addition. The particles act together with the β-crystallites in a synergistic manner, so that a reduction of the β proportion in the film does not result in a lower Gurley value. The improved gas permeability can also be exploited in a positive manner by increasing the process speed, since the particles contribute to improving the Gurley value, i.e. particle-containing films in accordance with the invention with the same Gurley values can be produced faster, i.e. more cost-effectively.

Surprisingly, it has been shown that, despite increasing the process speed, the amount of tearing does not increase significantly when the film contains the particles in accordance with the invention.

In other words, by means of the present invention, a film can be provided which, because of the particularly high permeability, is suitable for application in high energy batteries.

Furthermore, the film can advantageously be used in other applications in which a very high permeability is required or would be advantageous. An example is as a high porosity separator in batteries, in particular in lithium batteries with a high power demand.

The following measurement methods are used to characterize the raw materials and the films:

### Particle Size:

The mean particle size is determined by means of a laser scattering method in accordance with ISO 13320-1. An example of suitable measurement equipment for analysis is a Microtrac S 3500.

The size of the agglomerates and the absolute particle size may be examined using a scanning electron microscope. In this regard, either a SEM image of particles painted onto a sample carrier is taken, or a SEM image of a film sample with a size of 10 mm² on a platinum or gold sputtered film sample is taken, or a SEM image is taken of granulates from a master batch. The film sample or the other appropriate images of the particle or batch are examined optically for the presence of particles with a particle size of more than 1 μm.

### Melt Flow Index

The melt flow index of the propylene polymers was measured in accordance with DIN 53 735 under a 2.16 kg load and at 230° C.

### Melting Point

In the context of the present invention, the melting point is the maximum on the DSC curve. In order to determine the melting point, a DSC curve is recorded with a heating and cooling speed of 10K/l min in the range 20° C. to 200° C. In order to determine the melting point, as is usual, the second heating curve following the 10K/l min cooling from 200° C. to 20° C. is evaluated.

### β-Content

The proportion of β-crystalline polypropylene was determined using DSC. This characterization has been described in the Journal of Applied Polymer Science, vol 74, pp: 2357-2368, 1999 by Varga and was carried out as follows: the sample supplemented with β-nucleation agent is initially heated in the DSC at a heating rate of 20° C./min to 220° C. and melted (1^{st} heating). Following this, it is cooled at a cooling rate of 10° C./min before it is then melted again at a heating rate of 10° C./min (2^{nd} heating).

From the DSC curve for the 1^{st} heating, the degree of crystallinity K_{β,DSC} (fraction of β-crystalline polypropylene) which is present in the sample being analysed (unstretched film, injection moulded part) is calculated from the ratio of the melting enthalpies for the β-crystalline phases (H_{β}) to the sum of the melting enthalpies of β- and α-crystalline phases (H_{β}+H_{α}). The percentage value is calculated as follows:

K_{β,DSC}[%]=100×(H_{β})/(H_{β}+H_{α})

From the DSC curve for the 2^{nd} heating, the degree of crystallinity K_{β,DSC} [%] (2^{nd} heating) is determined from the ratio of the melting enthalpies for the β-crystalline phase (H_{β}) to the sum of the melting enthalpies for the β and α-crystalline phases (H_{β}+H_{α}) which provides the maximum β-fraction for the respective polypropylene sample which can be obtained.

### Density

The density is determined in accordance with DIN 53 479.

### Maximum and Mean Pore Size

The maximum and mean pore size was measured by means of the bubble point method in accordance with ASTM F316.

### Porosity

The reduction in density (ρ_{film}−ρₚₚ) of the film with respect to the density of the pure polypropylene, ρₚₚ, is calculated as the porosity as follows:

Porosity[%]=100×(ρₚₚ-β_{film})/ρₚₚ

### Permeability (Gurley Value)

The permeability of the films was measured with the Gurley Tester 4110 in accordance with ASTM D 726-58. To this end, the time (in sec) was determined for 100 cm³ of air to permeate through a film surface area of 1 inch² (6.452 cm²). The pressure difference through the film corresponded to the pressure of a column of water 12.4 cm high. The time required then corresponds to the Gurley value, i.e. the unit is in sec/100 cm³.

The invention will now be explained in more detail with the aid of the following examples.

### EXAMPLES

### Example A

### Batch Production

In a first step, a batch formed from polymer and particles was produced which was then used in the subsequent experiment. This batch was produced as follows:

60% by weight of a TiO₂ pigment (Huntsmann TR28) together with 0.04% by weight of calcium pimelate as the nucleation agent (calcium pimelate) were mixed, melted and granulated in a twin-screwed extruder at a temperature of 230° C. and with a screw rotation speed of 270 rpm with 39.96% by weight of granulated isotactic polypropylene homopolymer (melting point 162° C., MFI 3 g/10 min). The SEM images of the batch exhibited finely divided TiO₂ particles with a particle size of 20 to 500 nm with no agglomerates over 1 μm. The β activity of the batch was at a value of 91% for the second heating.

### Example B

### Film Production

### Film Example: 1

After the extrusion process, a double-layered pre-film was extruded from a wide slit nozzle at an extrusion temperature of 240° C. to 250° C. The throughputs of the extruder were selected here such that the ratio of the thicknesses of the layers A:B was 1:2. The multi-layered pre-film was initially drawn off onto a cooling roller and cooled. Next, the pre-film was oriented in the longitudinal and transverse directions and finally fixed. The layers of film had the following composition:

### Composition of Layer A:

40% by weight TiO₂ batch in accordance with Example A formed from:

| | |
|---|---|
| 60% by weight | TiO₂ |
| Approx. 39.96% by weight | propylene homopolymer |
| 0.04% by weight | nucleation agent |

respectively with respect to the batch 60% by weight of polypropylene mixture, formed from:

Approx. 60% by weight propylene homopolymer (PP) with an n-heptane soluble fraction of 4.5% by weight (with respect to 100% PP) and a melting point of 165° C.; and a melt flow index of 3.2 g/10 min at 230° C. and 2.16 kg load (DIN 53 735), and

Approx. 39.96% by weight of propylene-ethylene block copolymer with an ethylene fraction of approx. 5% by weight with respect to the block copolymer and a melt flow index (230° C. and 2.16 kg) of 6 g/10 min

0.04% by weight of nano Ca pimelate as the β-nucleation agent

respectively with respect to the mixture.

### Composition of Layer B:

Approx. 80% by weight of propylene homopolymer (PP) with an n-heptane soluble fraction of 4.5% by weight (with respect to 100% PP) and a melting point of 165° C.; and a melt flow index of 3.2 g/10 min at 230° C. and 2.16 kg load (DIN 53 735), and

Approx. 19.96% by weight of propylene-ethylene block copolymer with an ethylene fraction of approx. 5% by weight with respect to the block copolymer and a melt flow index (230° C. and 2.16 kg) of 6 g/10 min

0.04% by weight of nano Ca pimelate as the β-nucleation agent.

The layers of film additionally contained stabilizers and neutralization agents in the usual quantities. The nano Ca-pimelate was produced as described in Examples 1a or 1b of WO2011047797.

After extrusion, the polymer mixture was drawn over a first take-off roller and a further roller trio, cooled and solidified, then longitudinally stretched, transversely stretched and fixed; in detail, the following conditions were selected:
Extrusion: extrusion temperature 245° C.
Cooling roller: temperature 125° C.
Take-off speed: 1.5 m/min (dwell time on the take-off roller: 55 sec)
Longitudinal stretching: preheat rollers: 92
   stretching roller T=90° C.
Longitudinal stretching by factor of 3.6
Transverse stretching: heating zone T=145° C.
Stretching zone T=145° C.
Transverse stretching by factor of 4.8
Convergence: 13%

A roll of 1500 m run length was run with no tearing. The porous film produced in this manner was about 30 μm thick and had a density of 0.33 g/cm³ and had a uniform, white-opaque appearance. The porosity was 66% and the Gurley value was 160 s. SEM images of the surface of side A exhibited no TiO₂ agglomerates and no particles with a particle size of >1 μm on an examined surface area of 10 mm².

### Film Example 2

A double-layered film was produced as described in Film Example 1, with the difference that the take-off speed was increased to 2.5 m/min. The composition of the layers as well as the other process conditions were unchanged. Despite the increased take-off speed, 800 m run lengths were prepared without tearing. The thickness was reduced to 20 μm in this case. Despite the shorter dwell time on the take-off roller, the Gurley value was surprisingly reduced to approx. 140 seconds. In this film too, no TiO₂ agglomerates and no particles with a particle size of >1 μm on a surface area of 10 mm² were identified on side A using SEM.

### Film Example 3

A double-layered film was produced as described in Film Example 1, with the difference that the layer B now had the same composition as layer A. The composition of layer A as well as the process conditions were unchanged. Thus, in fact, a single-layered film was produced. The thickness of the film was 31 μm and the Gurley value was surprisingly reduced to less than 100 seconds. This composition also exhibited very good run stability, and thus a roll with a 2000 m run length was produced. Both sides of the film exhibited no TiO₂ agglomerates and no particles with a particle size of >1 μm on a surface area of 10 mm² in SEM.

### Film Example 4

An actual single-layered film with 24% by weight of TiO₂ was produced as described in Film Example 3. The take-off speed (as in Film Example 2) was increased to 2.5 m/min. the (same) composition of the layers A and B as well as the remaining process conditions were unchanged. With the increased take-off speed of 2.5 m/min, a roll of 1000 m run length was produced without tearing. The thickness here was reduced to 20 μm and the Gurley value surprisingly remained below 100 seconds, as was the case for Ex 3. In this film, on both sides, no agglomerates and no particles with a particle size of >1 μm on a surface area of 10 mm² were identified using SEM.

### Film Example 5

A single-layered film with 24% by weight of TiO₂ was produced as described in Film Example 3, with the difference that the polypropylene mixture now did not contain any nucleation agents and thus had the following composition: approx. 60% by weight of propylene homopolymer (PP) with a n-heptane soluble proportion of 4.5% by weight (with respect to 100% PP) and a melting point of 165° C.; and a melt flow index of 3.2 g/10 min at 230° C. and under 2.16 kg load (DIN 53 735), and approx. 40% by weight of propylene-ethylene block copolymer with an ethylene fraction of approx. 5% by weight with respect to the block copolymer and a melt flow index (230° C. and 2.16 kg) of 6 g/10 min.

Otherwise, the composition of the layer and the composition of the TiO₂ batch as well as the process conditions were unchanged compared with Example 3.

Here again, a roll of 1000 m run length could be prepared without tearing. The thickness of the film was 28 μm. Surprisingly, the Gurley value, as was the case with Film Example 3, remained below 100 seconds. In this film too, in both layers no agglomerates and no particles with a particle size of >1 μm over a surface area of 10 mm² were identified using SEM.

### Film Example 6

A double-layered film was produced as described in Film Example 1, with the difference that in layer A, the concentration of TiO₂ batch was increased to 60% and the fraction of polypropylene mixture was reduced to 40% so that 36% by weight of TiO₂ was present in layer A. The composition of layer B as well as the process conditions were unchanged. Here again, this composition exhibited very good run stability and a roll with a 1000 m run length was produced. The thickness of the film was 27 μm and the Gurley value was surprisingly reduced to less than 100 seconds. Side A of the film exhibited no agglomerates of >1 μm over a surface area of 10 mm² using SEM. However, one particle with a particle size of approx. 1.2 μm was identified.

### Film Example 7

A double-layered film was prepared under the same conditions and using the same formulation as in Film Example 2. However, the take-off speed was increased to 5 m/min, and thus the final film speed was increased to 19 m/min. In order to produce a film with the same thickness under these conditions, the extrusion throughput was also doubled. This composition also exhibited a very good run stability at the higher process speed and a roll with a 1000 m run length was produced. The thickness of the film was 27 μm and the Gurley value compared with Example 2 was raised to 170 seconds, wherein the β-content measured for the pre-film was reduced slightly to 57%. Side A of the film exhibited no agglomerates and no particles with a particle size of >1 μm over a surface area of 10 mm² using SEM.

### Film Example 8

A double-layered film was prepared under the same conditions and using the same formulation as in Film Example 2. However, the take-off speed was increased to 7.5 m/min, and thus the final film speed was increased to 28 m/min. In order to produce a film with the same thickness under these conditions, the extrusion throughput was also doubled. This composition also exhibited a very good run stability at the higher process speed and a roll with a 1000 m run length was produced. The thickness of the film was 24 μm and the Gurley value compared with Example 7 was raised to 198 seconds, wherein the β-content measured for the pre-film was reduced slightly to 54%. Side A of the film exhibited no agglomerates and no particles with a particle size of >1 μm over a surface area of 10 mm² using SEM.

### Film Example 9

A double-layered film was prepared under the same conditions and using the same formulation as in Film Example 2. However, the take-off speed was increased to 10 m/min, and thus the final film speed was increased to 37 m/min. In order to produce a film with the same thickness under these conditions, the extrusion throughput was also doubled. This composition also exhibited a very good run stability at the higher process speed, and a roll with a 1000 m run length was produced. The thickness of the film was 24 μm and the Gurley value compared with Example 8 was raised to 222 seconds, wherein the β-content measured for the pre-film was reduced slightly to 51%. Side A of the film exhibited no agglomerates and no particles with a particle size of >1 μm over a surface area of 10 mm² using SEM.

### Film Example 10

A double-layered film was prepared under the same conditions and using the same formulation as in Film Example 2. However, in layer A and layer B, the propylene-ethylene block copolymer was changed by increasing the proportion of propylene homopolymer (PP). This composition again exhibited a very good run stability, despite missing the block copolymer, and a roll with a 1000 m run length was produced. The thickness of the film was 27 μm and the Gurley value was 170 seconds. This composition also exhibited a very good run stability, and so a roll with 1000 m run length was produced. Side A of the film exhibited no agglomerates and no particles with a particle size of >1 μm over a surface area of 10 mm² in SEM.

### Comparative Example 1

A film was produced under the same conditions as in Film Example 1, with the difference that for layer A the same mixture as for layer B was used, and thus the TiO₂ addition was dispensed with. The composition of layer B as well as the process conditions were unchanged. In actual fact, a single-layered film was produced. The thickness of the film was 29 μm and the Gurley value was 200 seconds.

### Comparative Example 2

A film was produced under the same conditions as in Film Example 1, with the difference that the take-off speed here was increased to 2.5 m/min. With the higher take-off speed, 500 m run length were prepared without tearing. The thickness was reduced to 20 μm and the Gurley value increased to 280 seconds.

### Comparative Example 3

A double-layered film was produced under the same conditions as in Film Example 1, with the difference that the composition of the batch for layer A was changed. The TiO₂ was replaced by an Al₂O₃ with a mean particle diameter of 3 μm. The composition of the polypropylene mixture for layer A, the composition of layer B as well as the process conditions were unchanged. However, in fact a film could not be produced because of the large amount of tearing.

### Comparative Example 4

A double-layered film was produced under the same conditions as in Film Example 1. However, the TiO₂ was introduced by direct addition to the extruder instead of using a batch. Frequent tearing occurred during production. The few films which were produced in principle had the same properties as the film of Example 1. Side A of the film displayed several agglomerates with a size of 1 to 3 μm over a surface area of 10 mm² using SEM.

| | | Comp Ex 1 | Comp Ex 2 | Ex 1 | Ex 2 | Ex 3 | Ex 4 | Ex 5 | Ex 6 |
|---|---|---|---|---|---|---|---|---|---|
| Particle | | / | / | TiO₂ | TiO₂ | TiO₂ | TiO₂ | TiO₂ | TiO₂ |
| material | | | | | | | | | |
| Mean particle | nm | | | 200 | 200 | 200 | 200 | 200 | 200 |
| size | | | | | | | | | |
| Particle shape | | | | spherical | spherical | spherical | spherical | spherical | spherical |
| Conc of | % | 0.04 | 0.04 | 0.04 | 0.04 | 0.04 | 0.04 | 0 | 0.04 |
| nucleation | | | | | | | | | |
| agent | | | | | | | | | |
| Film structure | | single- | single- | double | double | single- | single- | single- | double |
| | | layer | layer | layer- | layer- | layer | layer | layer | layer- |
| | | | | A/B | A/B | | | | A/B |
| Conc. of TiO₂ | % by | 0 | 0 | 24 | 24 | 24 | 24 | 24 | 36 |
| in layer A | wt | | | | | | | | |
| Ratio A/B | | | | 1:2 | 1:2 | | | | 1:2 |
| Run length | m | 500 | 500 | 1600 | 800 | 2000 | 1000 | 1000 | 800 |
| without tearing | | | | | | | | | |
| Take-off speed | m/min | 1.5 | 2.5 | 1.5 | 2.5 | 1.5 | 2.5 | 1.5 | 1.5 |
| Agglomerates | | | | 0 | 0 | 0 | 0 | 0 | 1 |
| with a size | | | | | | | | | |
| >1 μm over 10 mm² | | | | | | | | | |
| Process speed | m/min | 5.92 | 9.25 | 5.92 | 9.25 | 5.92 | 9.25 | 5.92 | 5.92 |
| Thickness | μm | 29 | 20 | 30 | 20 | 31 | 20 | 28 | 27 |
| Density | kg/m³ | 0.32 | 0.33 | 0.34 | 0.35 | 0.35 | 0.37 | 0.37 | 0.33 |
| Porosity | % | 60.5 | 59.5 | 58.5 | 57.5 | 57.5 | 55.5 | 55.5 | 59.5 |
| Maximum pore | nm | 65 | 63 | 79 | 76 | 146 | 152 | 146 | 84 |
| size | | | | | | | | | |
| Mean pore size | nm | 57 | 54 | 58 | 57 | 119 | 109 | 112 | 67 |
| Gurley value | s/100 cm³ | 199 | 280 | 160 | 138 | 91 | 98.9 | 99.9 | 144 |
| β-content, pre- | % | 66 | 64 | 63 | 64 | 66 | 62 | 61 | 66 |
| film | | | | | | | | | |

| | | Ex 7 | Ex 8 | Ex 9 | Ex 10 |
|---|---|---|---|---|---|
| Particle material | | TiO₂ | TiO₂ | TiO₂ | TiO₂ |
| Mean particle size | nm | 200 | 200 | 200 | 200 |
| Particle shape | | spherical | spherical | spherical | spherical |
| Conc of nucleation | % | 0.04 | 0.04 | 0.04 | 0.04 |
| agent | | | | | |
| Film structure | | double layer- | double layer- | double layer- | double layer- |
| | | A/B | A/B | A/B | A/B |
| Conc of TiO₂ in | % by | 24 | 24 | 24 | 24 |
| layer A | wt | | | | |
| Ratio A/B | | 1:2 | 1:2 | 1:2 | 1:2 |
| Run length without | m | 1000 | 1000 | 1000 | 1000 |
| tearing | | | | | |
| Take-off speed | m/min | 5 | 7.5 | 10 | 2.5 |
| Agglomerates with a | | 0 | 0 | 0 | 0 |
| size >1 μm over 10 mm² | | | | | |
| Process speed | m/min | 18.50 | 27.75 | 37.00 | 9.25 |
| Thickness | μm | 27 | 24 | 21 | 30 |
| Density | kg/m³ | 0.37 | 0.39 | 0.41 | 0.34 |
| Porosity | % | 55.5 | 53.5 | 51.5 | 58.5 |
| Maximum pore size | nm | 64 | 66 | 69 | 76 |
| Mean pore size | nm | 56 | 57 | 57 | 57 |
| β-content, pre-film | % | 55 | 53 | 50 | 72 |
| Gurley value | s/100 cm³ | 170 | 196 | 222 | 170 |

1.-26. (canceled)

27. A biaxially oriented, single- or multi-layered porous film which comprises at least one porous layer and this layer contains at least one propylene polymer, at least one β-nucleation agent and particles, wherein the particles have a melting point of more than 200° C. and at most one agglomerate or at most one particle with a particle size of >1 μm is detectable on a SEM image of a 10 mm² film sample of the biaxially oriented, single- or multi-layered porous film.

28. The film as claimed in claim 27, wherein the porosity is produced by transformation of β-crystalline polypropylene upon stretching the film, wherein at least one β-nucleation agent is present in the film.

29. The film as claimed in claim 27, wherein the film contains 2% to 60% by weight of particles with respect to the weight of the porous layer.

30. The film as claimed in claim 27, wherein the β-nucleation agent is a calcium salt of pimelic acid and/or of suberic acid and/or an iron oxide and/or nickel pimelate.

31. The film as claimed in claim 27, wherein no agglomerates and no particles with a particle size of >1 μm can be detected on a SEM image of a 10 mm² film sample.

32. The film as claimed in claim 27, wherein the particles have a mean particle size of <1 μm.

33. The film as claimed in claim 27, wherein the particles are not vacuole-initiating particles.

34. The film as claimed in claim 27, wherein the porous layer of the film contains at least 65% by weight of propylene polymers.

35. The film as claimed in claim 27, wherein the porous layer of the film contains 50% to 85% by weight of propylene polymer, 15% to 50% by weight of propylene block copolymer and 50 to 10000 ppm of β-nucleation agent.

36. The film as claimed in claim 27, wherein the density of the film is in the range 0.1 to 0.5 g/cm³ and it has a Gurley value of less than 150 s.

37. The film as claimed in claim 27, wherein the particles are inorganic spherical particles.

38. The film as claimed in claim 27, wherein the particles are not vacuole-initiating particles, wherein vacuole-initiating particles are particles which, upon biaxial stretching of a polypropylene film without β-nucleation agents, reduce the density of the polypropylene film to <0.85 g/cm³.

39. The film as claimed in claim 27, wherein the particles are inorganic particles.

40. The film as claimed in claim 27, wherein the particles are TiO₂.

41. The film as claimed in claim 27, wherein the particles are organic particles.

42. A process for the production of a porous film by process A or process B wherein process A comprises the following steps:
(i) extruding an at least single-layered polypropylene film, in which propylene polymer and β-nucleation agent and particles with a melting point of more than 200° C. are melted in an extruder and extruded through a flat nozzle onto a take-off roller,
(ii) next, the extruded molten film is cooled and solidified, with the formation of β-crystallites,
(iii) next, the film from step (ii) is stretched in the longitudinal direction and thereafter in the transverse direction, and
(iv) the process speed is 5 to 200 m/min or
process B which comprises the following steps:
(i) extruding an at least single-layered polypropylene film, in which propylene polymer and no β-nucleation agent and particles with a melting point of more than 200° C. are melted in an extruder and extruded through a flat nozzle onto a take-off roller,
(ii) next, the extruded molten film is cooled and solidified, with the formation of β-crystallites,
(iii) next, this film is stretched in the longitudinal direction and thereafter in the transverse direction,
wherein the film is produced at a process speed of 5 m/min to 200 m/min and in that at most one agglomerate or at most one particle with a particle size of >1 μm is detectable on
a SEM image of a 10 mm2 film sample of the biaxially oriented, single- or multi-layered porous film.

43. The process as claimed in claim 42, wherein the particles are mixed with at least one polypropylene to form a batch and the particle-containing batch is mixed with polypropylene and melted in the extruder.

44. The process as claimed in claim 42, wherein a dispersing agent is added during the manufacture of the particle-containing batch.

45. A high energy or high performance systems containing the film as claimed in claim 27.

46. A biaxially oriented, single- or multi-layered film A or B which comprises
A. at least one porous layer and this layer contains at least one propylene polymer, a β-nucleation agent and particles, wherein the particles have a melting point of more than 200° C. and a mean particle size of <1 μm or
B. at least one porous layer and this layer contains at least one propylene polymer and particles, wherein the particles have a melting point of more than 200° C. and a particle size of <1 μm, wherein the porous layer contains no β-nucleation agents.

47. The film as claimed in claim 46, wherein the film is film B and further contains no block copolymers and the porous layer has a Gurley value of less than 500 s.

48. The biaxially oriented, single- or multi-layered film as claimed in claim 46, wherein at most one agglomerate or at most one particle with a particle size of >1 μm is detectable on a SEM image of a 10 mm² film sample of the biaxially oriented, single- or multi-layered porous film.
